(19) United States
(12) Patent Application Publication
(10) Pub. No.: US 2007/0176743 A1
(43) Pub. Date: Aug. 2, 2007

(54) Information and paging system

(76) Inventor: Dennis Brian Murphy, Tempe, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/331,099

(22) Filed: Jan. 13, 2006

(51) Int. Cl. H04Q 1/30

(52) U.S. Cl. 340/7.29; 340/311.2; 340/825.19

(57) ABSTRACT

The present invention is a Passenger Information and Paging System (PIPS). Through PIPS, individuals can send and receive paging messages in a public forum such as airports, train stations, cruise ship terminals, shopping malls, conference centers, sports arenas, and the like. PIPS is configured to enable individuals with various physical impairments to readily send and receive paging messages. PIPS is a paging system that incorporates visual based paging along with audio paging. Through incorporating visual paging, PIPS allows those individuals who are hearing impaired to also send and receive paging messages. In addition, PIPS is provided with a plurality of kiosks that are equipped with a variety of interactive components to enable individuals of varying physical abilities to send and receive paging messages.

### FIELD OF THE INVENTION

The present invention relates to the field of networked information systems, and more in particular to a visually based paging system.

### BACKGROUND OF THE INVENTION

Paging systems in airports and other public and private venues are currently audio based systems. When a person wishes to page another individual in an airport for instance, they would call the airport operator from outside the airport via an external phone line or within the airport via the well known “white paging phone.” The airport operator collects these page requests and then periodically announces the names of individuals having paging messages over the airport's audio broadcast system. Those individuals whose names were announced over the audio system would then proceed to the white paging phone to receive their message. This type of audio based paging is common in airport terminals through out the United States and the world, along with other public and private venues.

This audio based paging system has numerous flaws. Foremost, as an audio based system, those individuals who are hearing or speech impaired are unable to utilize the system. Further, individuals with other physical disabilities may prove unable to utilize the audio based paging system through an inability to access, inter alia, the paging phone to send or receive messages. As a result, it is extremely desirable to develop a paging system that is fully accessible to individuals of all physical abilities.

A further flaw in these audio based systems is the fact that it is commonly difficult to hear pages over the audio system due to the poor sound quality of public audio broadcast systems or the high level of ambient noise. Further, individuals who are utilizing head-phones that are a part of a portable MP3 player, portable visual player, cell phone or the like are unable to hear their names broadcast over the audio paging system.

An additional flaw in audio based paging systems is that the names of paged individuals are only announced audibly on a semi-periodic basis. Consequently, individuals who are distracted or are not otherwise paying attention to the audio paging system may easily miss hearing their names being paged. Further, individuals who are in transit at airport terminals or train stations may not remain in the vicinity of the audio paging system long enough to hear their names announced on the paging system.

### SUMMARY OF THE INVENTION

The present invention is directed to a paging system that would facilitate public paging in other public forums such as shopping centers, conference centers, sporting arenas, and other public areas.

An embodiment of the present invention is a Passenger Information and Paging System (PIPS). PIPS is configured to enable individuals with various physical impairments to readily send and receive paging messages. PIPS is a paging system that incorporates visual based paging along with audio paging. Through incorporating visual paging, PIPS allows those individuals who are hearing impaired to also send and receive paging messages. In addition, PIPS is provided with a plurality of kiosks that are equipped with a variety of interactive components to enable individuals of varying physical abilities to send and receive paging messages. Through PIPS, individuals can send and receive paging messages-in a public forum such as airports, train stations, cruise ship terminals, shopping malls, conference centers, sports arenas, and the like.

Messages entered into the PIPS systems are reviewed for content in a communications control center prior to posting on the PIPS system. Messages that are approved for posting are then broadcast over an audio and/or visual system to inform identified individuals that a paging message is awaiting retrieval at one of the plurality of kiosks.

### BRIEF DESCRIPTION OF THE DRAWINGS

FIG. 1 depicts a block diagram of the Passenger Information and Paging System (PIPS).

FIG. 2 depicts an isometric view of a Paging Assistance Locator (PAL) kiosk.

FIG. 3 depicts another isometric view of a Paging Assistance Locator (PAL) kiosk.

FIG. 4 depicts a front view of a Paging Assistance Locator (PAL) kiosk.

FIG. 5 depicts a top view of a Paging Assistance Locator (PAL) kiosk.

FIG. 6 depicts a side view of a Paging Assistance Locator (PAL) kiosk.

FIG. 7 depicts a bank of Visual Paging Displays (VPD).

FIG. 8 depicts a flowchart for posting a message from a Paging Assistance Locator.

FIGS. 9-17 depicts a series of computer screen displays for posting a message from a Paging Assistance Locator.

FIG. 9 depicts an initial passenger welcome computer screen display.

FIG. 10 depicts a computer screen display where a passenger chooses to create or access or a message.

FIG. 11 depicts a warning computer screen display informing passengers that messages are not private.

FIG. 12 depicts a computer screen display where the pager enters their first name.

FIG. 13 depicts a computer screen display where the pager enters their last name.

FIG. 14 depicts a computer screen display where the pager enters the pagee's first name.

FIG. 15 depicts a computer screen display where the pager enters the pagee's last first name.

FIG. 16 depicts a computer screen display where the pager enters the message.

FIG. 17 depicts a computer screen display where the pager verifies the accuracy of the paging information.

FIG. 18 depicts a VPD paging screen illustrating the posted paging message information.

FIG. 19 depicts a flow chart for accessing a message from a Paging Assistance Locator (PAL) kiosk.

FIGS. 20-22 depicts a series of computer screen displays for accessing a message from a Paging Assistance Locator (PAL) kiosk.

FIG. 20 depicts a pagee identifier computer screen display.

FIG. 21 depicts a message retrieval computer screen display.

FIG. 22 depicts a paging message computer screen display.

FIG. 23 depicts a help menu screen display.

FIG. 24 depicts a computer screen display for conducting a help chat session from a Paging Assistance Locator (PAL) kiosk.

FIG. 25 depicts a live chat session window for Paging Assistance Locator (PAL) kiosk help.

FIG. 26 depicts a message management computer screen display.

FIG. 27 depicts a message properties computer screen display.

### DETAILED DESCRIPTION OF THE PREFERRED EMBODIMENTS

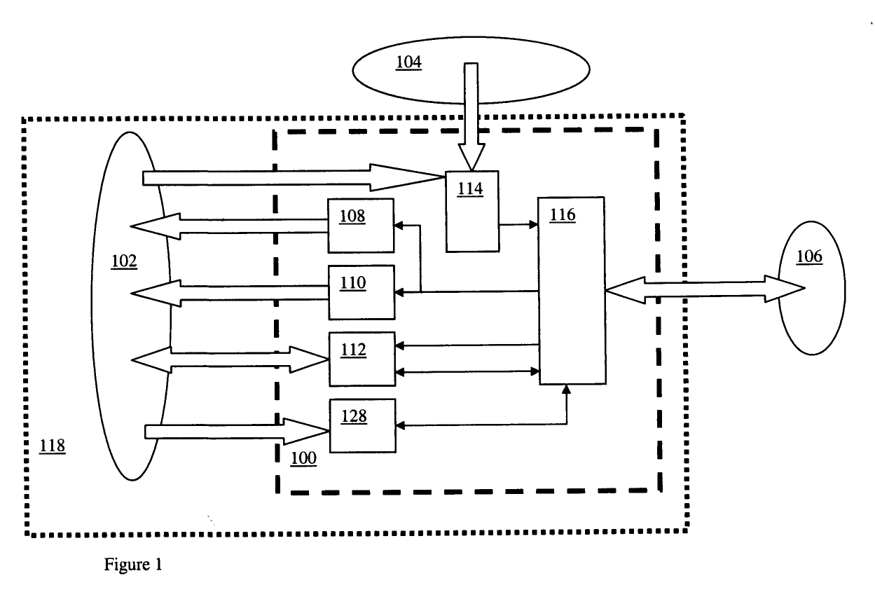

Referring to the Figures by characters of reference, FIG. 1 depicts a block diagram of Passenger Information and Paging System (PIPS) 100. PIPS 100 allows individuals 102 and 104 to send paging messages in a public or private forum. Paging messages are then reviewed for content by a communications center operator 106 for content prior to posting the message on PIPS 100. Individuals 102 can then access paging messages approved by the communications center operator 106 that are posted PIPS 100.

PIPS 100 is provided with an audio broadcast system 108, a visual broadcast system 110, and a network of Paging Assistance Locator (PAL) kiosks 112. PIPS 100 is also provided with an External Communications Interface (ECI) 114 and a communications center computer network 116.

PIPS 100 is preferably located within a public or private forum 118 such as an airport. Other locations 118 for PIPS 100 include train stations, cruise ship terminals, shopping malls, conference centers, sports arenas, and the like. While some components of PIPS 100, such as ECI 114 and communications center computer network 116 are shown within location 118, these components may in fact be located outside of location 118. Individual 102 is representative of a person located within location 118. Individual 104 is representative of a person located outside of location 118.

Individual 102 can leave paging messages with PIPS 100 through interacting with PAL kiosk 112. PAL kiosk 112 is an integrated network component of PIPS 100. PAL kiosk 112 communicates bi-directionally with PIPS 100. Individual 102 can also leave paging messages through an a general airport phone 128. Individual 102 can also use ECI 114 via a cell phone.

Individual 104 can leave paging messages with PIPS through ECI 114. Individual 104 may chose to leave a paging message through either a telephone call to PIPS 100 or by means of an internet paging web site, or other means of communication. ECI 114 is provided to receive communications that are external to PIPS 100 such as outside telephone calls or web based messages.

ECI 114 receives communications external to PIPS 100 and converts the paging messages to text messages. These text messages are sent to communications center computer network 116 for review by communications center operator 106. While shown as located outside of location 118, communications center operator 106 may reside within location 118.

Communications center operator 106 reviews paging messages posted by individuals 102 and 104 for content. Operator 106 can either be a human operator, or a software application that performs the same functions. Communications center operator 106 may reject paging messages based upon the content of the paging message. Rejected paging messages are not posted on PIPS 100. For those messages that do not have inappropriate content, the communications center operator 106 may approve the message for posting on PIPS 100.

Paging messages that are approved for posting on PIPS 100 are broadcast through a variety of methods. Paging messages approved for posting on PIPS 100 are broadcast on audio paging system 108, visual paging system 110, and the network of PAL kiosks 112. Through incorporating both audio and visual paging, PIPS 100 enables those individuals who are either visually impaired or hearing impaired to recognize that they have a paging message awaiting them for retrieval on PIPS 100. Audio paging system 108 is generally comprised of an array of speakers located strategically within location 118. On audio paging system 108, the names of individuals who have a paging message awaiting them on PIPS 100 are audibly announced. When desirable, the entire paging message may also be audibly announced over audio paging system 108. In addition, individuals who are paged audibly over audio paging system 108 are directed to acquire their paging message from one of the plurality of PAL kiosks 112.

Visual paging system 110 is generally includes an array of visual displays, such as plasma display screens, Cathode Ray Tubes (CRTs), Liquid Crystal Displays (LCDs), Organic Light Emitting Diode (OLED) displays, or other visual display screens. These visual displays may be placed individually, in pairs, or in banks of visual display screens throughout location 118. Visual paging system 110 allows for the continuous display of the names of individuals who have paging messages posted on PIPS 100. The paging messages left on PIPS 100 may also be scrolled across each of the visual displays comprising visual paging system. The visual displays comprising visual paging system 110 are also located strategically throughout location 118.

Individuals 102 may also acquire paging messages posted on PIPS 100 through one of the plurality of PAL kiosks 112. Each PAL kiosk 112 is equipped with a variety of interactive tools to allow individuals 102 of varying physical abilities to send and access paging messages. PAL kiosks 112 are equipped with visual monitors and touch screen visual displays to facilitate the visual transfer of paging message information. PAL kiosks 112 are also provided with telephone receivers for the audible transfer of paging message information. PAL kiosks 112 also include a headphone jack to enable individuals 102 to audibly acquire paging information.

PAL kiosks 112 are provided with brail signage to support the use by visually impaired individuals 102. PAL kiosks 112 are also provided with a tactile keyboard having concave key surfaces to allow an individual to use a stick like tool to depress the keys, thereby allowing individuals who cannot use the touch screen or telephone receiver unit to interact with PIPS 100. PAL kiosks 112 also have a screen navigational tool replicating the functions of a conventional computer mouse. The combination of these features on PAL kiosks 112 makes each PAL kiosk 112 highly accessible to individuals 102 having varying physical impairments, such as a lack of hearing, a lack of sight, a lack of use of one's arms, or other impairment.

Together, the combination of audio paging system 108, visual paging system 110, and plurality of PAL kiosks 112 creates an improved paging system with greater utility than purely audio based paging system. The use of audio paging system 108 and visual paging system 110 supplement the paging capabilities of PAL kiosks 112.

When configuring a location 118 with PIPS 100, it is desirable to have a large number of visual displays forming visual paging system 110 distributed throughout location 118. It is also desirable to having a large number of speakers forming audio paging system 108 distributed throughout location 118. It is then desirable to have an appropriate number of PAL kiosks 112 distributed throughout location 118 to enable individuals 102 to send and receive paging messages. Having a plurality of interactive components, PAL kiosks 112 are more complex and expensive than the speakers or visual displays forming audio paging system 108 and visual paging system 110. As such, strategic placement of the components of audio paging system 108 and visual paging system 110 can reduce the number of PAL kiosks 112 required to outfit location 118 with PIPS 100.

PIPS 100 handles paging information in both text and audible forms. Paging information may be provided to PIPS 100 in either a text form or an audible form. PIPS 100 is configured to send paging information over visual broadcast system 110 and audio broadcast system 112 in both text and audible form. PIPS 100 is therefore configured to convert text information into voice information and convert voice information into text information. For instance, when PIPS 100 receives a paging message verbally, PIPS 100 will convert this audible message to a text message for processing by operator 106 and eventual display on visual broadcast system 110. PIPS 100 is also provided with a system to convert text into audible messages with the use of a computer generated or recorded voice.

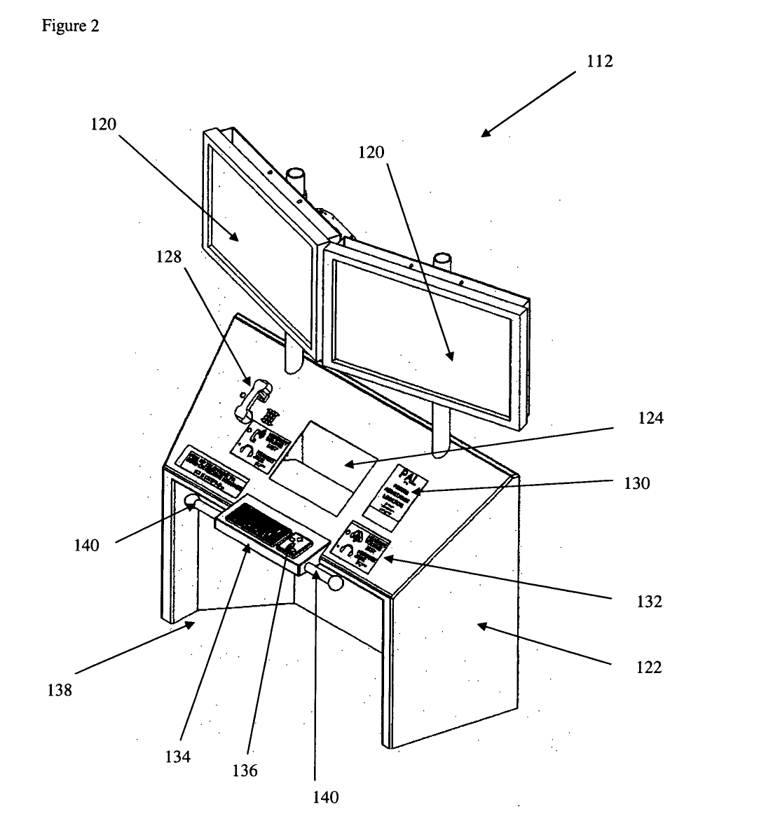

FIG. 2 depicts an isometric view of a Paging Assistance Locator (PAL) kiosk 112. PAL kiosk 112 includes a pair of monitors 120 mounted to a cabinet 122. A touch screen monitor 124 is provided in cabinet 122. Touch screen monitor 124 is driven by a computer 126 (not shown) contained within cabinet 122. A telephone/handset jack 128 is provided next to touch screen monitor 124. On the opposite side of touch screen monitor 124 is a brail sign 130 to enable the sight impaired to utilize PAL kiosk 112. Headphone jack 132 provided next to touch screen 124 allows for an increased ability to transfer message paging information audibly. A tactile keyboard 134 is provided in front of touch screen 124 to allow for the sending and receipt of paging messages. Tactile keyboard 134 has concave key surfaces so that an individual can depress the keys with a tube, straw, stick, or the like without it slipping off of the key surface. This enables individuals 102 who cannot use their hands but instead rely upon a pointed probe held in their mouth to operate the keyboard 134. The audio components of PAL kiosk 112, telephone/handset jack 128 and headphone jack 132 include a volume dial so that users may adjust the level of volume that they hear over these audio components.

Next to keyboard 134 is a screen navigational tool 136 that allows individual 102 to send and receive paging messages without use of keyboard 134. Navigational tool 136, for example, may comprise a conventional computer mouse device. Preferably, navigational tool 136 is a handicapped configured computer navigational tool that allows individual 102 to manipulate the cursor and text information on touch screen monitor 124. Screen navigational tool 136 may function in combination with an audio headset plugged into headphone jack 132 to enable a person to navigate through a series of audio menus provided on PIPS 100 as a part of the Call Automation Service (CAS) in order to send and receive paging information.

Cabinet 122 is provided with a lower recess 138 so that individuals 102 who rest in a wheel chair or other mobile device can comfortably pull up to PAL kiosk 112 and access PAL kiosk tools 124, 128, 130, 132, 134, and 136. Cabinet 122 is also configured with handle bars 140 to enable an individual to pull themselves toward and hold on to cabinet 122. Handle bars 140 also enable an individual to reposition themselves while seated in front of PAL kiosk 112.

While shown to have two display monitors 120, PAL kiosk 112 may have a single monitor 120, or three or more monitors 120. The use of two monitors in FIG. 2 is merely exemplary.

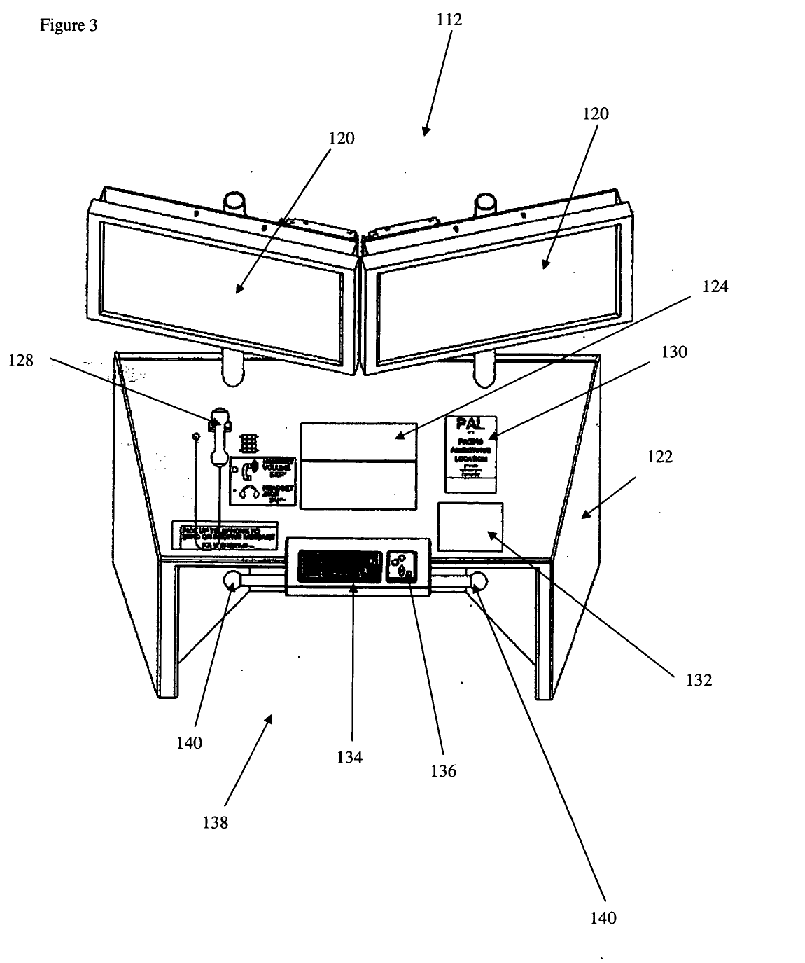

FIG. 3 depicts another isometric view of a Paging Assistance Locator (PAL) kiosk 112. Telephone jack/headset 128 includes a conventional telephone keypad, thereby allowing the user to connect to an operator and select menu options or dial other extensions. Monitors 120 are placed on cabinet 122 such that they form an obtuse angle to facilitate the visibility of the displayed information. Cabinet 122 is typically placed against a wall near a high traffic area such as a restrooms facility, intersection of walkways between buildings, terminals, or any other high traffic area. As cabinet 122 is placed against the wall or back to back, placing monitors 120 at an angle allows for individuals to see the monitors from a greater distance as they approach PAL kiosk 112 from either side.

Handle bars 140 include rounded ball shaped ends to provide a comfortable gripping surface for individuals who wish to hold on to them while accessing PAL kiosk 112. Handle bars 140 extend from either side of keyboard unit 134. While positioned in front of PAL kiosk 112 and holding onto handle bars 140, and individual can readily access telephone jack/headset 128, touch screen 124, keyboard 134, screen navigational tool 136, and headphone jack 132. In this position, the individual can leave and retrieve paging messages through the various devices provided with PAL kiosk 112.

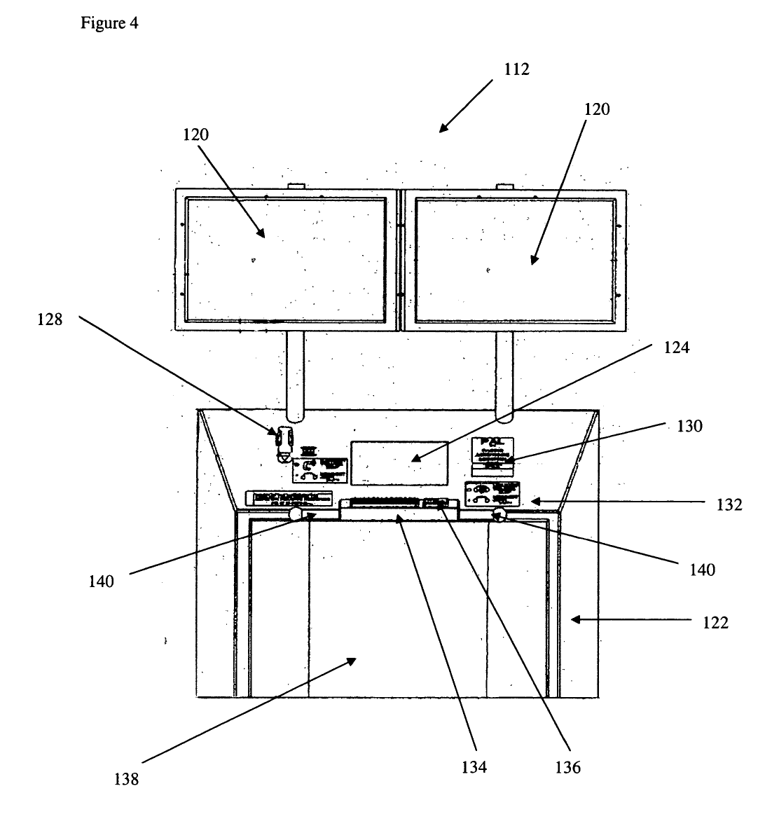

FIG. 4 depicts a front view of a Paging Assistance Locator (PAL) 112. PAL Kiosk 112 is configured so that keyboard 134 and screen navigational tool 136 are at the height of an average desk. As such, individuals can easily use keyboard 134 and screen navigational tool 136 whether they are in a standing position or in a seated position. Recess 138 is provided so that individuals who are seated in front of PAL kiosk 112 on a wheel chair, or other mobile assistance device can access and use PAL kiosk 112. PAL kiosk 112 and recess 138 are configured to be ADA compliant in height requirement for a wheel chair rolling under it.

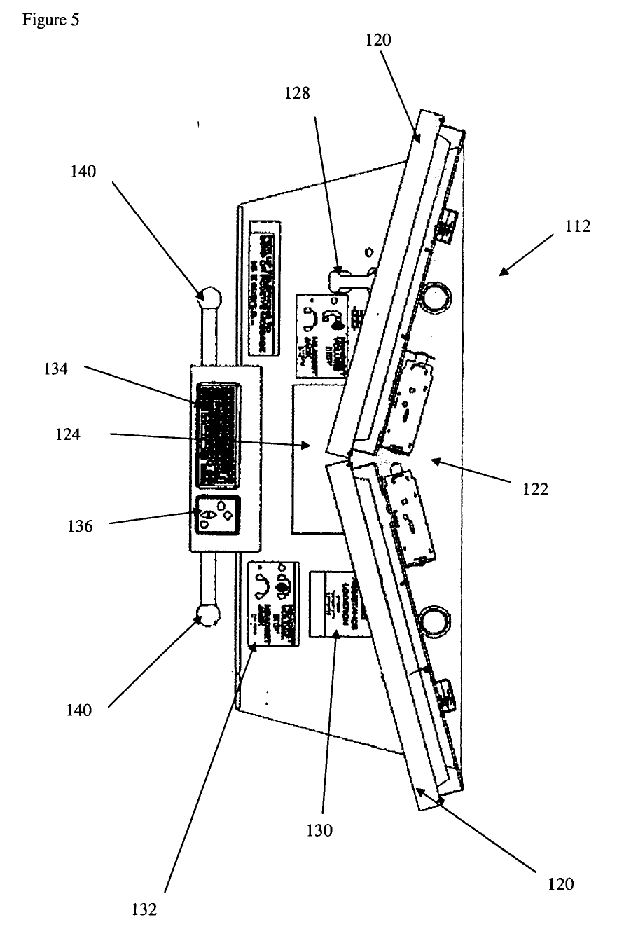

FIG. 5 depicts a top view of a Paging Assistance Locator (PAL) kiosk 112. Paging Assistance Location (PAL) 112 is a device that connects airport passengers to PIPS 100 so they can create and retrieve pages. Originally, the basic paging functions of PIPS 110 were traditionally made through the ‘white paging’ phones commonly found in airports. PAL kiosk 112 has expanded capabilities to accommodate people with special needs and certain ADA requirements (meeting challenges of those who are handicapped).

As discussed above, PAL kiosk 112 provides various modes of access for users with various capabilities to communicate. Users can communicate via standard phone handset 128 placed to talk with a live person 106 through PIPS 100. Users can also communicate via call automation using the standard key pad next to phone handset 128. Using touch screen 124 or keyboard 134, user can write or retrieve messages. Users can also send and retrieve messages on PAL kiosk 112 using screen navigational tool 136. Further, audio jack 132 is provided to enable a person to plug in a head set to enhance their ability to hear information from PAL kiosk 112. Keyboard 134 and touch screen 124 are run by a computer 126 residing inside PAL kiosk 112. PAL kiosk 112 also has displays 120 on the top of cabinet 122, which in this non-limiting example, includes two LCD monitors, which show the names of the people being paged.

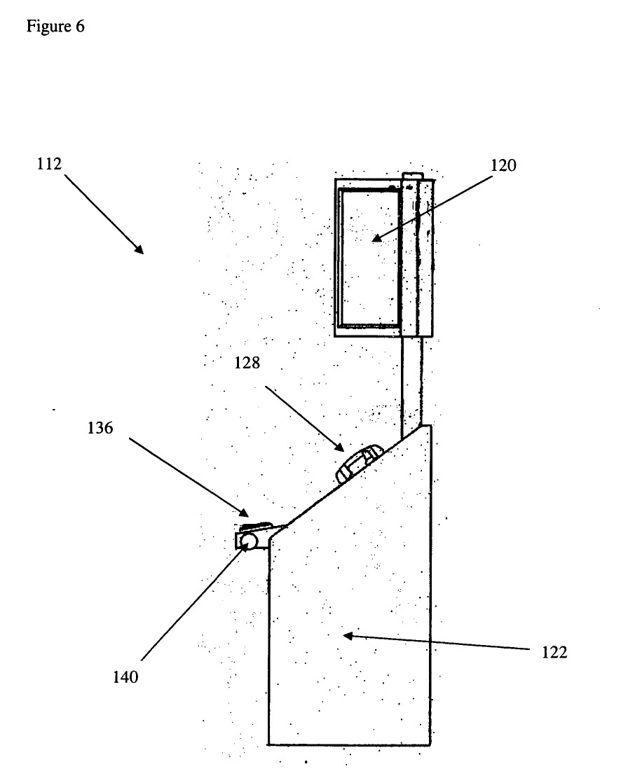

FIG. 6 depicts a side view of a Paging Assistance Locator (PAL) kiosk 112. Monitors 120 are placed so that they are at eye-level with an average standing person. As depicted in this figure, monitors 120 are placed at an angle with respect to cabinet 122 so that monitors 120 can be viewed from the sides of PAL kiosk 112. Handle bars 140 extend from the sides of the portion of cabinet 122 that supports screen navigation tool 136 and keyboard 134, thereby enabling a person to grip handle bars 140 around their entire circumference.

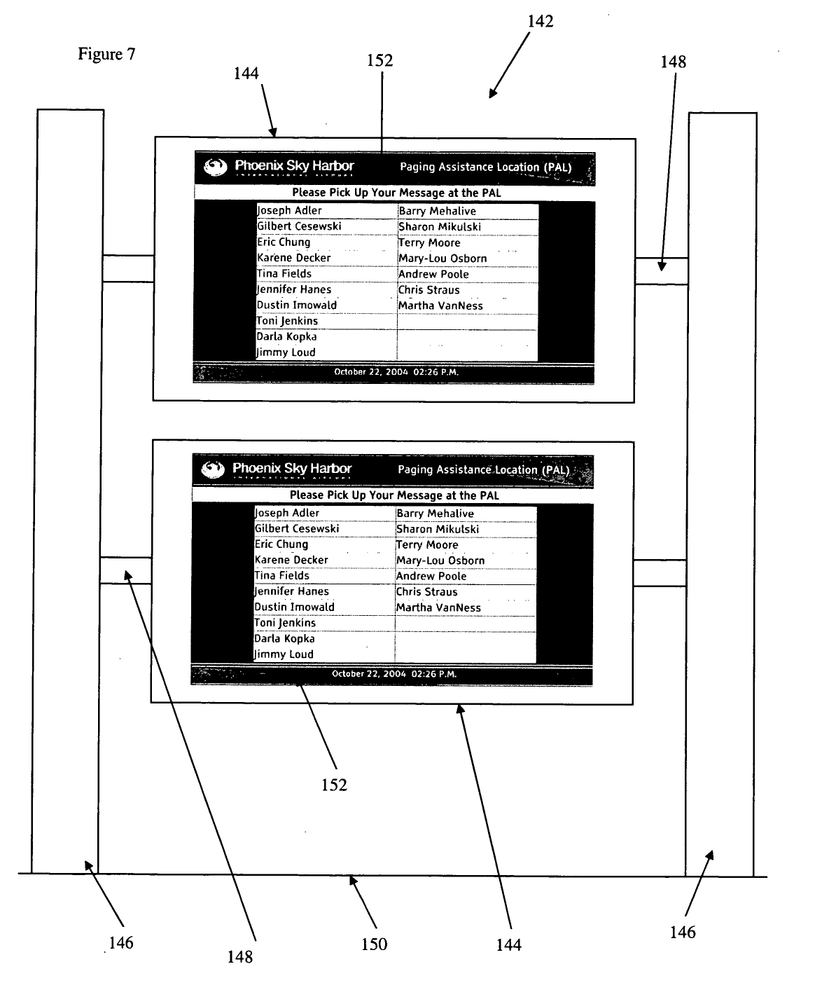

FIG. 7 depicts a bank of Visual Paging Displays (VPD) 142. In this exemplary non-limiting embodiment, VPD includes two monitors 144 that are mounted to vertical posts 146 with horizontal cross beams 148. VPD 142 is then mounted to the floor 150. While VPD 142 is shown having two monitors 144 stacked on top of each other, VPD 142 may comprise any number of monitors 144 in any configuration. For instance, in busy airports, VPD 142 may comprise two rows of monitors 144, which each row having eight monitors 144 or more.

Each monitor 144 displays paging information 152. In this non-limiting example, paging information 152 is comprised of the names of individuals who have a paging message posted on PIPS 100 awaiting retrieval. Paging information 152, in this example also includes the name of location 118, which is Phoenix Sky Harbor Airport. Individuals who have their name included in paging information 152 are alerted to proceed to a PAL kiosk 112 or other interface, such as a white paging phone, in order to retrieve their message. Paging information 152 may comprise other information besides the listing of individual's names who have received a page. For instance, the text of an individual page may be displayed on monitor 144. The text of an individual page could be scrolled across the bottom of monitor 144, or the entire message could be shown on monitor 144. Monitors 144 may also be used to display gate information, emergency information such as information related to a fire or other emergency incident. Different monitors 144 may display different information.

The use of VPDs 142 compliments the use of PAL kiosks 112. It is highly desirable to inform individuals who have been paged that they have a page waiting. With monitors 144 and VPDs 142 costing less than PAL kiosks 112, it is desirable to position a large number of VPDs 142 throughout location 118 with a select number of PAL kiosks 112 at strategic high traffic locations. As such, this configuration of PIPS 100 maximizes the ability to inform individuals at location 118 that they have a page waiting for them, without having to position a large number of PAL kiosks 112 through location 118. In addition to cost, space at location 118 is also a concern. At least at airport locations 118, there is an extremely high demand for any possible floor space by newspaper distributors wanting to place newspaper racks, stores, sales kiosks, advertising, etc. As such, the use of VPDs 142, which take up less floor space than PAL kiosks 112, helps to reduce the amount of overall floor space used by PIPS 100. VPDs 142 may also be strategically placed on walls or hanging from ceilings in order to display paging information 152.

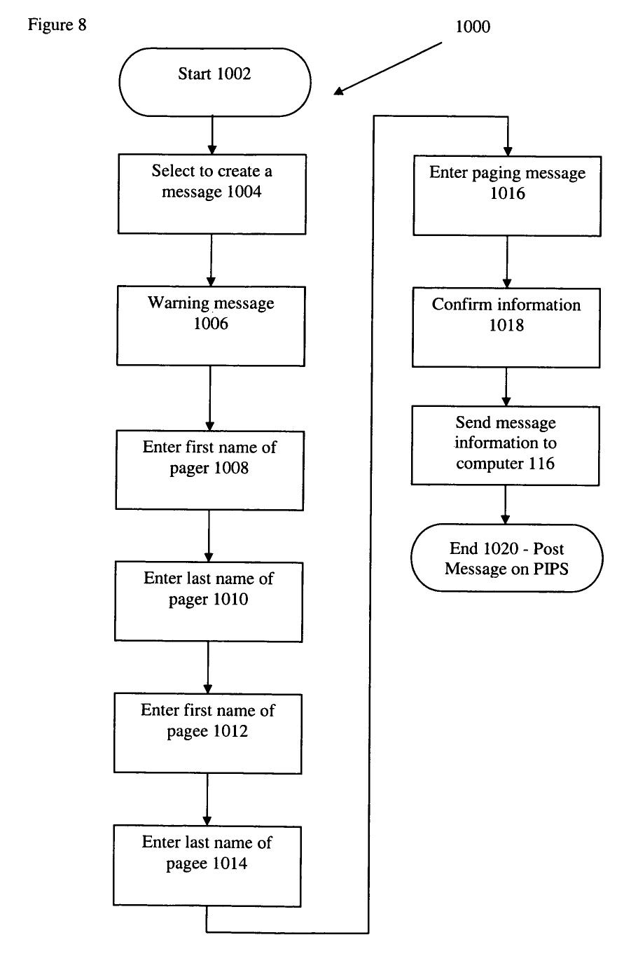

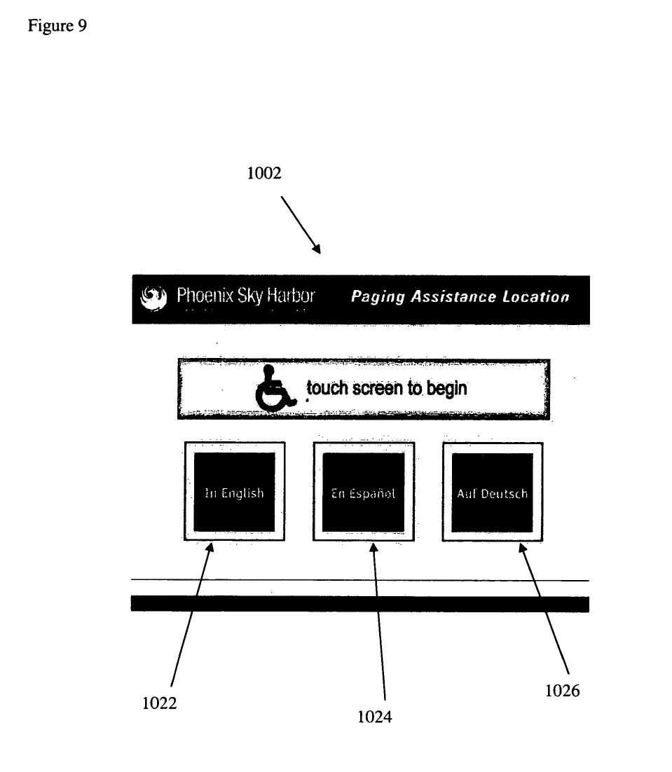

FIG. 8 depicts a flowchart 1000 depicting a sequence of screen displays, which are shown individually in FIGS. 9-17, for posting a message from a Paging Assistance Locator (PAL) kiosk 112. These screen displays are shown on PAL kiosk 112 by touch screen 124. The user operates and navigates these screen displays using either the touch screen 124, keyboard 134, or screen navigational tool 136. If the user does not wish to use any of these tools to produce a text paging message as outlined in flowchart 1000, they can utilize telephone handset 128 and leave a message verbally in the same manner that conventional “white paging phones” are used in airports today. Instead of white paging phone, users can use telephone handset 128 in conjunction with the CAS (call automation system) functionality. CAS is a computer driven phone response system. CAS enables users to send and retrieve messages through listening to menus supported on the computer over the phone and making menu selections verbally or with the numeric keypad next to telephone handset 128. Handset 128 could also take the form of a speakerphone. The process for leaving a message begins with an initial welcome display screen 1002 depicted in FIG. 9.

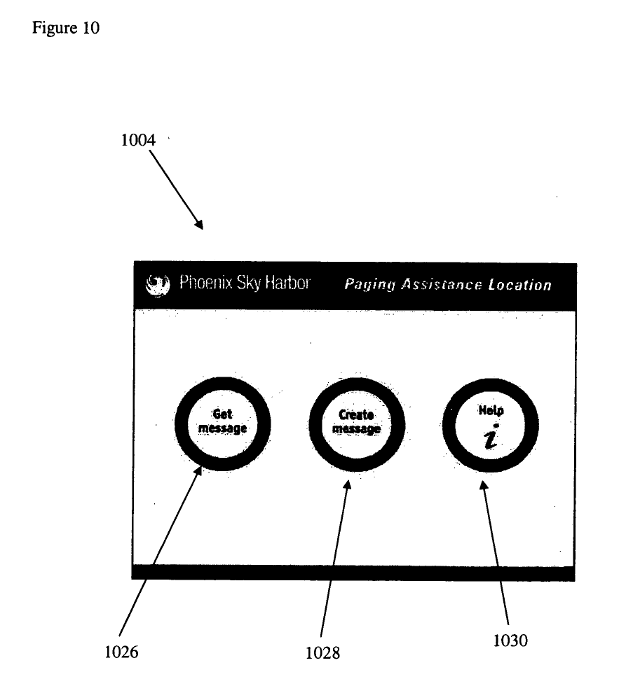

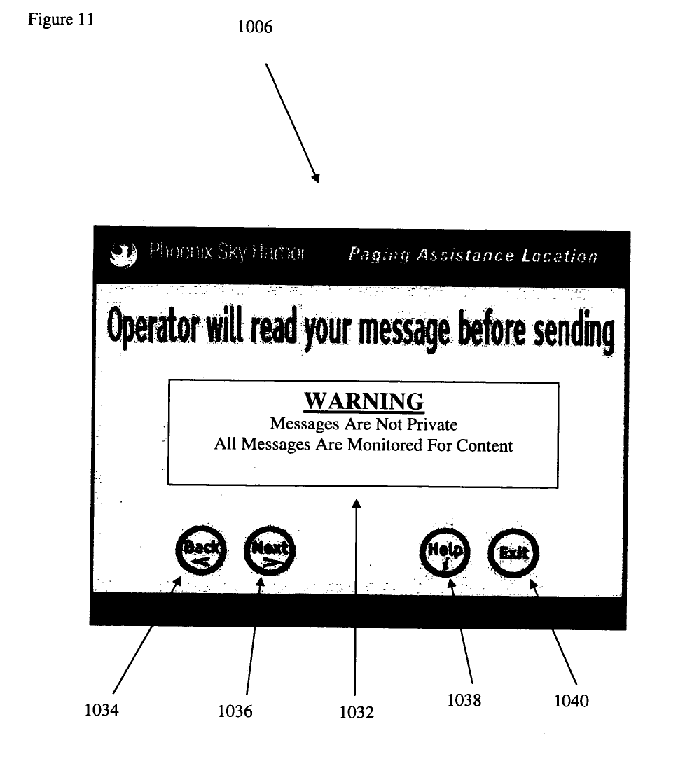

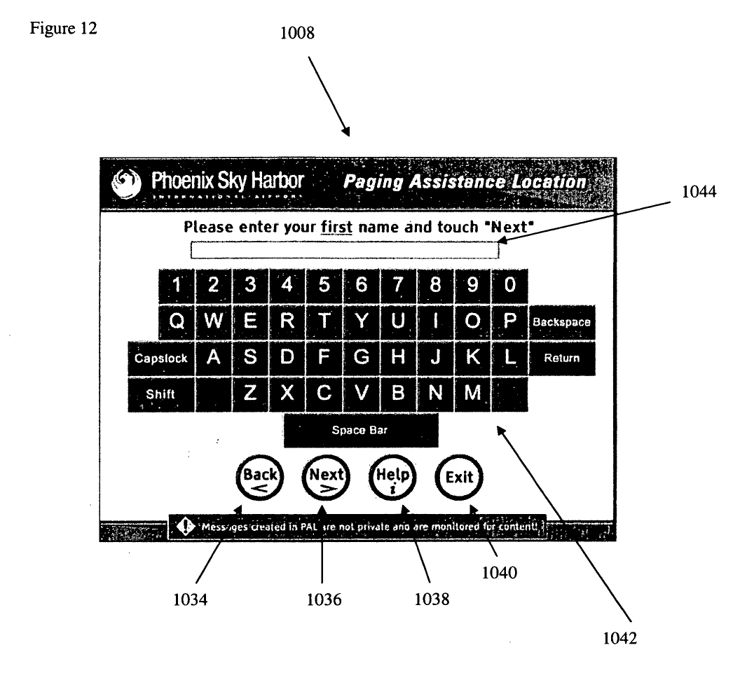

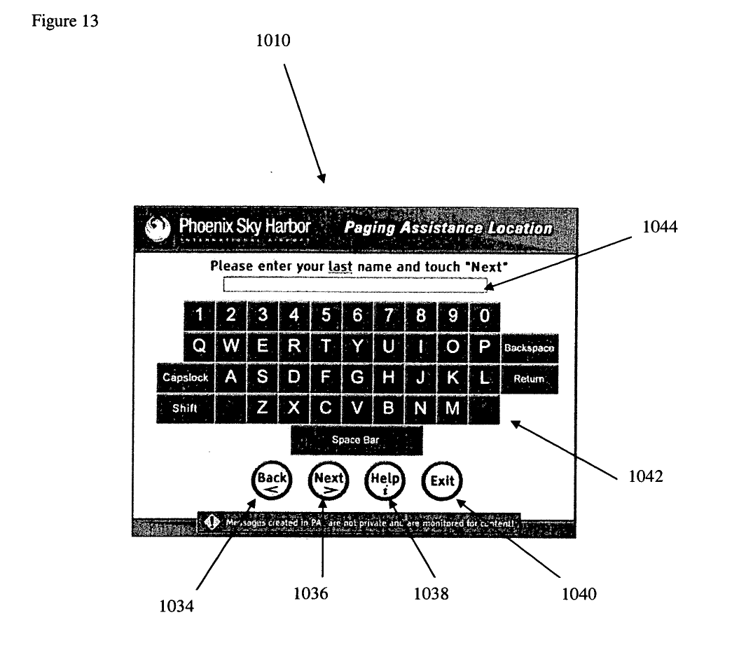

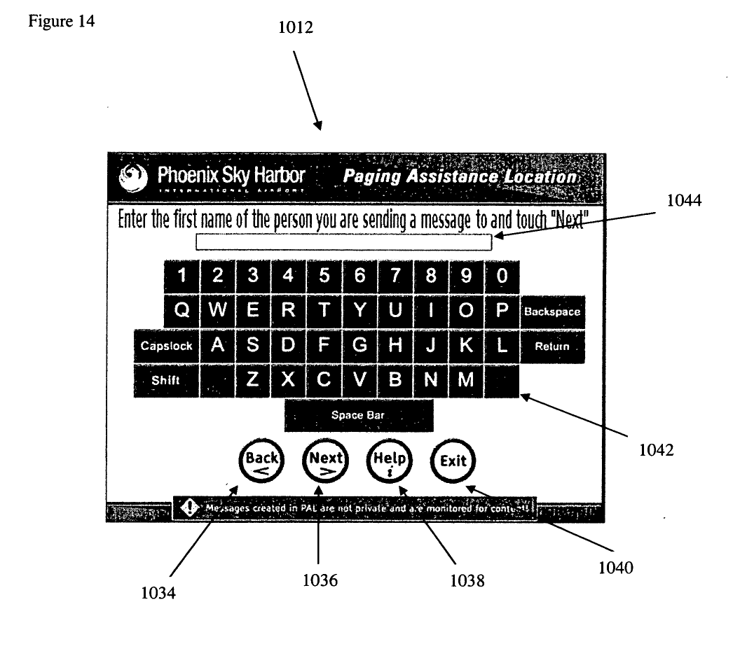

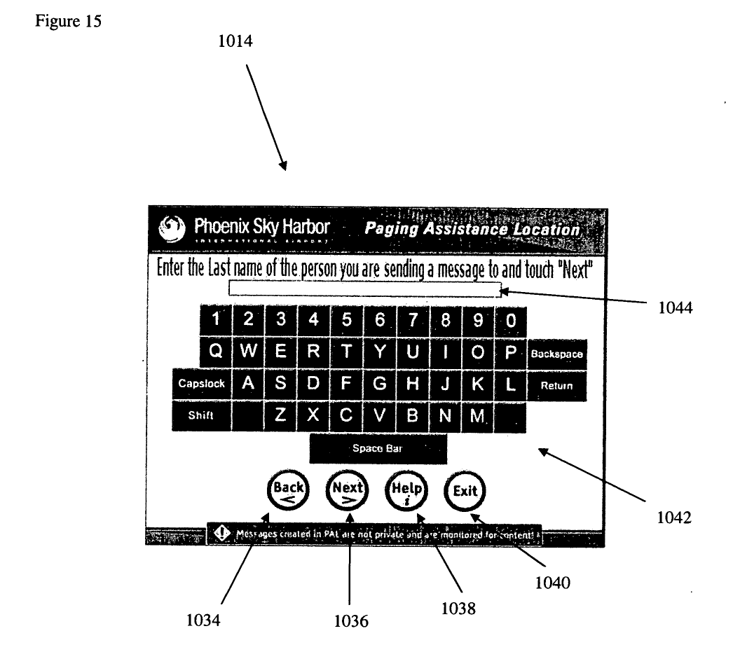

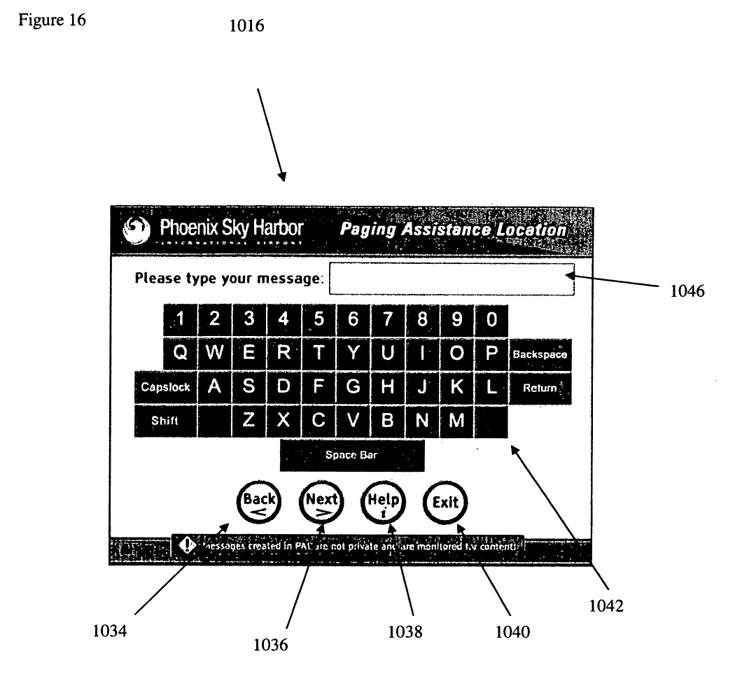

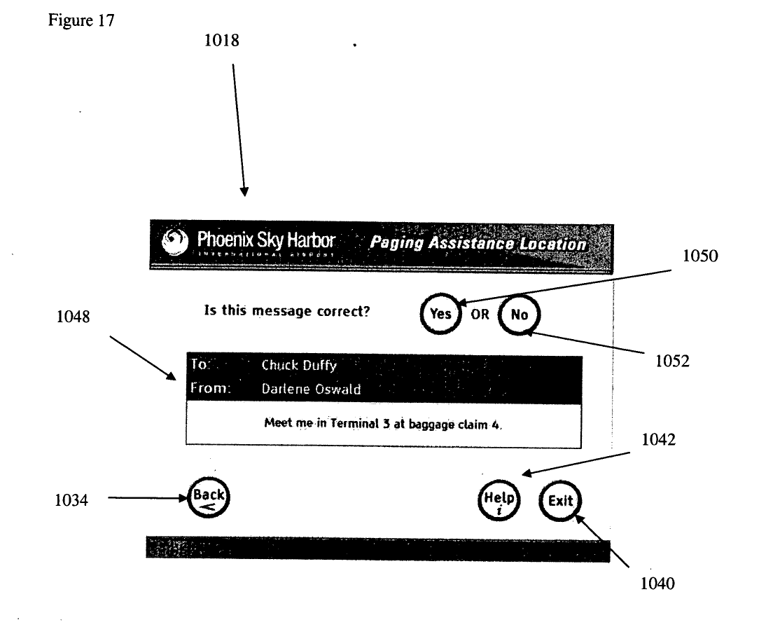

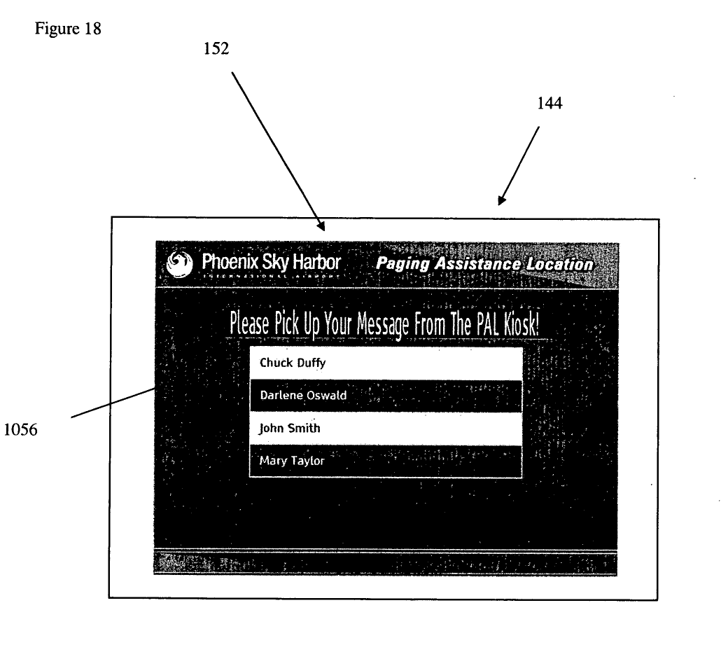

From the initial welcome display screen 1002, a user proceeds to a second screen 1004 depicted in FIG. 10 where the user selects to create a paging message. Next, the user is presented with a screen display 1006 depicted in FIG. 11 warning them that any information that they provide will be generally accessible to the public. After that warning, the user is presented with a screen display 1008 depicted in FIG. 12 where the user enters their first name. Next, the user is presented with a screen display 1010 depicted in FIG. 13 where the user enters their last name. Then, the user is presented with a screen display 1012 depicted in FIG. 14 where the user enters the first name of the person to be paged. Next, the user is presented with a screen display 1014 depicted in FIG. 15 where they enter the last name of the person to be paged. After entering this information, the user is presented a screen display 1016 depicted in FIG. 16 where they enter the message they wish to convey to the person that they are paging. The user is then presented with another screen display 1018 depicted in FIG. 17 where they have the opportunity to review all of the paging information they have entered including their name, the name of the person that they are paging, and the text of their message. FIG. 18 then depicts an exemplary set of visual paging information as it would appear on a monitor 120 or 144.

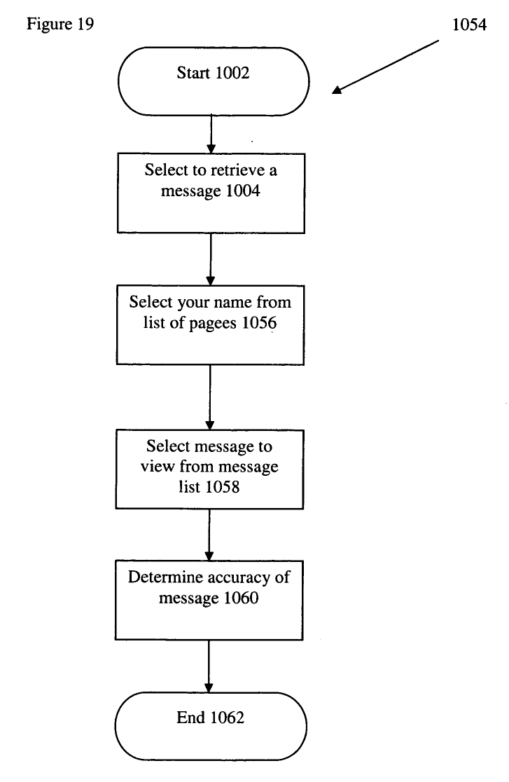

Once the user confirms this paging information, PAL kiosk 112 transmits the paging information to communications center computer network 116 where it is reviewed by an operator 106. Operator 106 reviews the content of the message. If operator 106 determines that the content of the message is suitable for public display on PIPS 100, operator 106 will post the message on PIPS 100. By posting the message on PIPS 100, the name of the person being paged will appear on display 144 as depicted in display information 152 as shown in FIG. 7. The text of the message may also be either posted or scrolled across monitors 144. In addition, display information 152 may also be posted in monitors 120 provided on PAL kiosks 112. Further, the name of the person being paged and the text of the paging message may be audibly broadcast over audio system 108. Once alerted of the paging message, the person being paged would then proceed to a PAL kiosk 112 where they would access the message via the set of screen displays depicted in FIGS. 19-22.

The screen displays depicted in FIGS. 9-17 are merely one of the methods that a person can leave paging information with PAL kiosk 112. As depicted in FIGS. 2-6, PAL kiosk 112 is provided with telephone 128 through which a person can leave their name, the name of the person being paged, and the paging message verbally as is currently done through the “white paging phone” in airports today. Software contained in communications center computer network 116 converts this audible information into text information that is then reviewed by operators 106 for content. If approved, operator 106 posts the message on PIPS 100 in the same manner as the message left via touch screen 124.

FIGS. 9-17 depict a series of computer screen displays for posting a message from a Paging Assistance Locator (PAL) kiosk 112. These computer display screen and the software that supports them are part of an application that provides the individual accessing PAL kiosk 112 with an interactive visual display 124 to request and retrieve paging messages. This software application is an integrated module of PIPS 100. This software application uses a standard web-browser interface that is displayed on touch screen 124. This software application supports three main functions: 1) message requests, which is the ability to send a page, 2) message retrievals, which is the ability to access and read a sent page, and 3) operator assistance, which is the ability to use a textual chat session with an operator 106 for paging assistance. FIG. 9 depicts an initial passenger welcome computer screen display 1002. Welcome screen 1002 provides a patron with the option to choose which language they would prefer to use when accessing the software. In this case, the user can select button 1022 for English, button 1024 for Spanish, or button 1026 for German. While English, Spanish and German are shown as available languages, the choice of these languages is merely exemplary and any language option may be provided with PIPS 100. Once selecting a language, which in this example is button 1022 for English, the user is presented with screen display 1004 that proves the user with the option to retrieve a message 1026, create a message 1028, or receive help 1030.

FIG. 10 depicts a computer screen display 1004 where a passenger chooses to create or access a message. In screen display 1004, the user may either choose button 1026 to get a message, button 1028 to create a message, or button 1030 to access a help software module. When utilizing screen display 1004 or any of the other screen displays, a user my employ keyboard 134, screen navigational tool 136, or touch screen 124 in order to make selections such as button 1026. In this example, the user will select button 1028 to create a message.

FIG. 11 depicts a warning computer screen display 1006 informing passengers that messages are not private. Computer screen display 1006 includes message 1032 that informs individuals using the interactive software application that messages are not private and that all messages are monitored for content. The user may select button 1034 is they wish to return to the previous screen display 1004, or select button 1036 to proceed to the next screen display 1008. The user may also select button 1038 to access the help module to receive either written instructions on how to use the software application or to open a live chat session with operator 106. The user may also select button 1040 to exit the software application all together. In this example the user selects button 1036 to proceed to the next screen which is computer screen display 1008.

FIG. 12 depicts a computer screen display 1008 where the pager enters their first name. Computer screen display 1008 includes an online keyboard 1042 and four option buttons 1034, 1036, 1038, and 1040. The user can touch the letters on keyboard 1042 with touch screen 124 to enter their first name. The name will be displayed in text box 1044 above keyboard 1042. The four available buttons are: back 1034, which returns the user to the previous screen 1006; next 1036 which continues to the next screen 1010 to proceed with creating a message; help 1038, which brings up the help options screen; and exit 1040, which exits the program and returns to the main screen, computer screen display 1002. As a reminder to the user, the warning message is displayed at the bottom of all screens that are part of the process of creating a message. Once the first name is entered, the user can touch the next button 1038 to proceed to the following screen 1010.

FIG. 13 depicts a computer screen display 1010 where the pager enters their last name. Computer screen display 1010 includes an online keyboard 1042 and four option buttons 1034, 1036, 1038, and 1040. The user can touch the letters on keyboard 1042 with touch screen 124 to enter their last name. The name will be displayed in text box 1044 above keyboard 1042. The four available buttons are: back 1034, which returns the user to the previous screen 1008; next 1036 which continues to the next screen 1012 to proceed with creating a message; help 1038, which brings up the help options screen; and exit 1040, which exits the program and returns to the main screen, computer screen display 1002. As a reminder to the user, the warning message is displayed at the bottom of all screens that are part of the process of creating a message. Once the last name is entered, the user can touch the next button 1038 to proceed to the following screen 1012.

FIG. 14 depicts a computer screen display 1012 where the pager enters the first name of the person to be paged. Computer screen display 1012 includes an online keyboard 1042 and four option buttons 1034, 1036, 1038, and 1040. The user can touch the letters on keyboard 1042 with touch screen 124 to enter the first name of the person to be paged. Alternatively, the user can employ screen navigational tool 136 or keyboard 134 to select the various screen options. The name will be displayed in text box 1044 above keyboard 1042. The four available buttons are: back 1034, which returns the user to the previous screen 1010; next 1036 which continues to the next screen 1014 to proceed with creating a message; help 1038, which brings up the help options screen; and exit 1040, which exits the program and returns to the main screen, computer screen display 1002. As a reminder to the user, the warning message is displayed at the bottom of all screens that are part of the process of creating a message. Once the first name is entered, the user can touch the next button 1038 to proceed to the following screen 1014.

FIG. 15 depicts a computer screen display 1014 where the pager enters the last name of the person to be paged. Computer screen display 1014 includes an online keyboard 1042 and four option buttons 1034, 1036, 1038, and 1040. The user can touch the letters on keyboard 1042 with touch screen 124 to enter the last name of the person to be paged. The name will be displayed in text box 1044 above keyboard 1042. The four available buttons are: back 1034, which returns the user to the previous screen 1012; next 1036 which continues to the next screen 1016 to proceed with creating a message; help 1038, which brings up the help options screen; and exit 1040, which exits the program and returns to the main screen, computer screen display 1002. As a reminder to the user, the warning message is displayed at the bottom of all screens that are part of the process of creating a message. Once the last name is entered, the user can touch the next button 1038 to proceed to the following screen 1016.

FIG. 16 depicts a computer screen display 1016 where the pager enters the message. Computer screen display 1016 includes an online keyboard 1042 and four option buttons 1034, 1036, 1038, and 1040. The user can touch the letters on keyboard 1042 with touch screen 124 to enter the paging message. The paging message will be displayed in text box 1046 above keyboard 1042. The four available buttons are: back 1034, which returns the user to the previous screen 1014; next 1036 which continues to the next screen 1018 to proceed with creating a message; help 1038, which brings up the help options screen; and exit 1040, which exits the program and returns to the main screen, computer screen display 1002. As a reminder to the user, the warning message is displayed at the bottom of all screens that are part of the process of creating a message. Once the paging message is entered, the user can touch the next button 1038 to proceed to the following screen 1018.

FIG. 17 depicts a computer screen display 1018 where the pager verifies the accuracy of the paging information. Paging information 1048 is displayed on computer screen display 1018. Paging information 1048 includes the name of the person being paged, the name of the person who sent the page, and the text of the paging message. Computer screen display 1018 includes the statement “Is this message correct” above paging information 1048. The user then has the option to select button 1050 or button 1052 for either yes or no. Pressing yes button 1050 confirms the accuracy of the message. Pressing no button 1052 allows the user to go back to the previous screen displays to make any changes. Back button 1034 allows the user to return to the previous screen display 1016. The help button 1042 connects the user to the help options screen. Exit button 1040 takes the user to the main menu display 1002.

Once the user presses yes button 1050, paging information 1048 is sent to communications center computer 116 for review by operator 106. If paging information 1048 includes objectionable content, operator 106 will reject and not post paging information 1048 on PIPS 100. Operator 106 may have the ability to send an acceptance message to the sender of the page informing them that their page has been accepted for posting on PIPS 100. If the content of paging information 1048 is acceptable, operator 106 will post the paging information 1048 on PIPS 100, which will broadcast paging information on audio broadcast system 108, visual broadcast system 110, and kiosks 112.

FIG. 18 depicts a VPD paging display 144 illustrating the posted paging message information 152. Paging message information 152 includes a list of names 1056 of individuals who have a paging message waiting for them at a PAL kiosk 112. The process outlined in FIGS. 9-17 culminates in the inclusion of the paged person's name in list 1056 displayed on screen 144. As such, the person who has been paged can see that they have been paged by viewing screen 144.

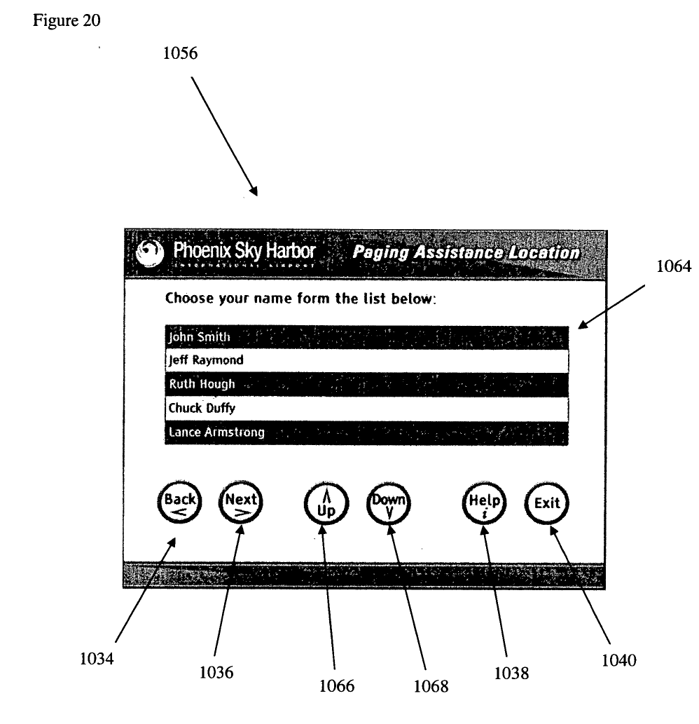

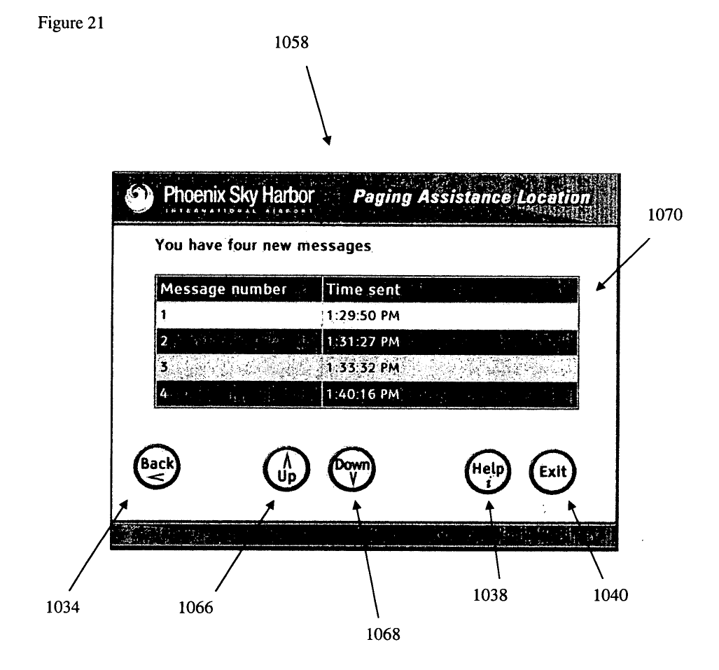

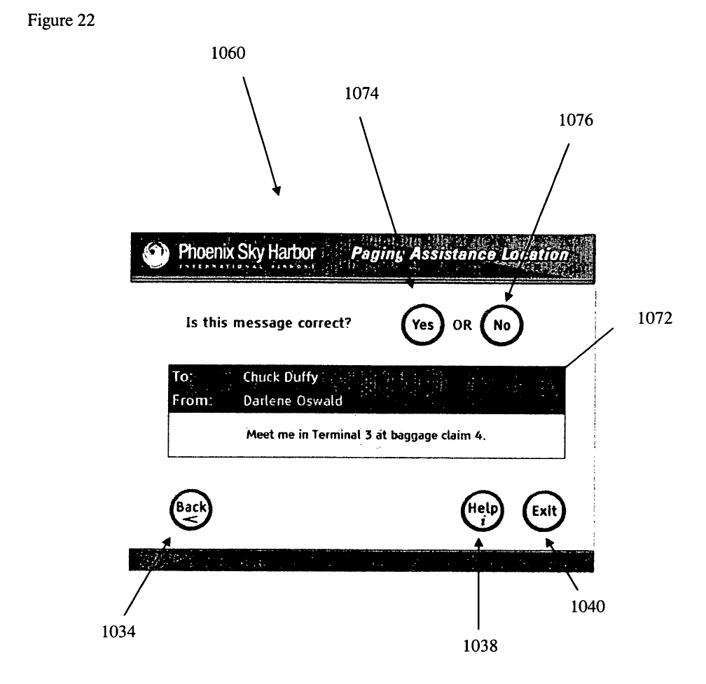

FIG. 19 depicts a flow chart of computer display screens 1054 depicted in FIGS. 20-22 for accessing a message from a Paging Assistance Locator (PAL) kiosk 112. The process beings with start screen 1002 which is depicted in FIG. 9. FIG. 9, as discussed above, depicts an initial passenger welcome computer screen display 1002. Welcome screen 1002 provides a patron with the option to choose which language they would prefer to use when accessing the software. Once selecting a language, which in this example is button 1022 for English, the user is presented with screen display 1004 depicted in FIG. 10 that proves the user with the option to retrieve a message 1026, create a message 1028, or receive help 1030. In this case, the user selects retrieve a message button 1026. The user is then provided with a screen display 1056 depicted in FIG. 20 where the user selects their name from the list of persons paged. Next, the user is presented with computer screen display 1058 depicted in FIG. 21 where they select a message to view. In computer screen display 1060 depicted in FIG. 22, the user can then verify whether the message was meant for them and return to the prior screen display. The process then terminates in step 1062 when the user has successfully retrieved their last message.

FIGS. 20-22 depicts a series of computer screen displays for accessing a message from a Paging Assistance Locator (PAL) kiosk 112. FIG. 20 depicts a pagee identifier computer screen display 1056. Computer screen display 1056 includes a listing of names of persons paged 1064. From viewing listing 1064, the user can highlight a specific name from the list using up button 1066 and down button 1068. Once the user selects their name from list 1064, they will press next button 1036 to take them to the following screen display 1058 that shows a listing of messages 1070. Back button 1034 takes the user to the previous screen display 1004. Help button 1038 activates the software application's help support. Button 1040 exits the user from the software application and returns them to the initial welcome display screen 1002.

FIG. 21 depicts a message retrieval computer screen display 1058. Computer screen display 1058 includes a listing of messages 1070. It is possible that the person paged on PIPS 100 may have more than one paging message waiting for them. As such, listing 1070 is provided so that the paged person may select which one of their messages to view. Listing of messages 1070 provides a numerical identifier for each message as well as the time the message was sent. From viewing listing 1070, the user can highlight a specific message from list 1070 using up button 1066 and down button 1068. Once the user selects the specific message from list 1070, they will press next button 1036 to take them to the following screen display 1060 that shows the text of the paging message. Back button 1034 takes the user to the previous screen display 1056. Help button 1038 activates the software application's help support. Button 1040 exits the user from the software application and returns them to the initial welcome display screen 1002.

FIG. 22 depicts a paging message computer screen display 1060. Computer screen display 1060 depicts a paging message 1072 that includes the name of the person who sent the page, the name of the person to whom the paging message is sent, as well as the text of the paging message. Computer screen display includes the question “is this message correct?” above paging message 1072. The user can then select the yes button 1074 or the no button 1076. Buttons 1074 and 1076 allow the user to tell PIPS 100 whether they have correctly accessed the message or if the message was meant for someone else. If the message was correctly theirs, then PIPS 100 can remove the message from list of messages 1070. When the user has accessed all of their messages, PIPS 100 will then remove the name of the paged person from list 1064. PIPS 100 may include a timing module that measure the amount of time that a message has been awaiting pick-up from kiosk 112. If the message is sitting on PIPS 100 for a specified amount of time without having been access, PIPS 100 may then automatically delete the message on the assumption that the paged person has left location 118 without having become aware of the page awaiting them on PIPS 100. PIPS 100 may be configured to have different time periods for deleting an message that has not been accessed by the person paged. For instance, PIPS 100 may delete the message after 30 minutes from display on visual broadcast system 100 but not delete the message from touch screen display 124 until after an hour passed from its initial posting. Back button 1034 takes the user to the previous screen display 1058. Help button 1038 activates the software application's help support. Button 1040 exits the user from the software application and returns them to the initial welcome display screen 1002.

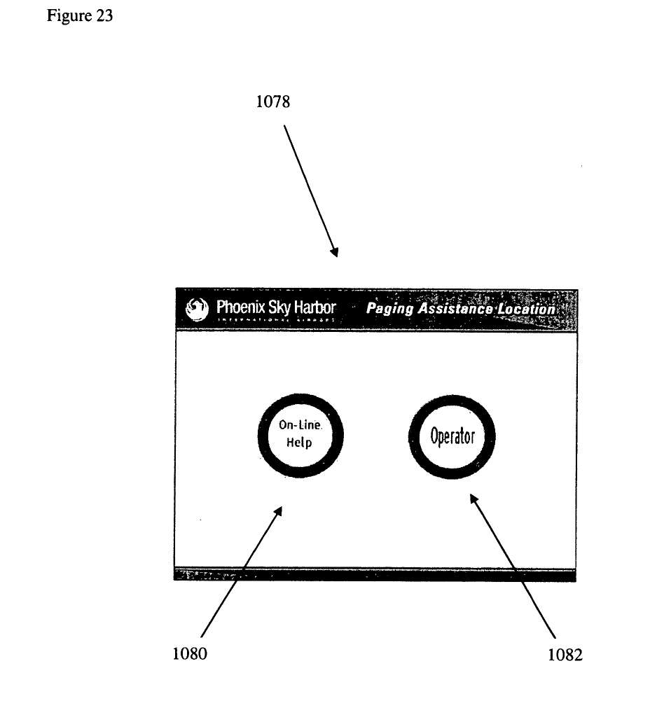

FIG. 23 depicts a help menu computer screen display 1078 for providing user support from a Paging Assistance Locator (PAL) kiosk 112. Help computer display screen 1078 includes two buttons, button 1080 for on-line help and button 1082 for operator 106. On-line Help button 1080 displays on-line PAL Application Help and Instructions. The PAL Application help is comprised of already prepared answers for standard questions regarding PIPS 100 that are contained within the software application. Operator button 1082 brings up an on-screen chat session with operator 106.

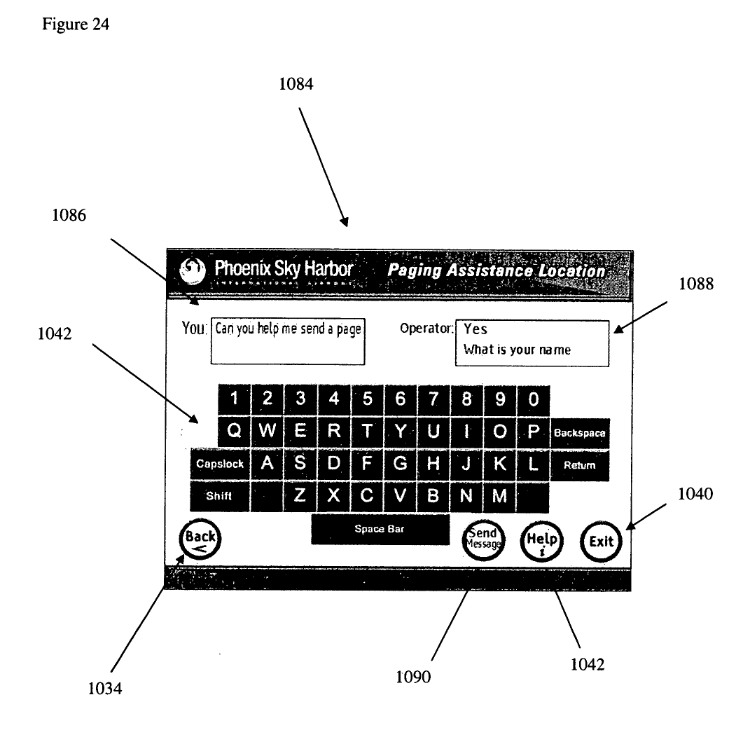

FIG. 24 depicts a help chat session computer screen display 1084. Computer display screen 1084 includes a keyboard 1042 that a user can operate via touch screen 124. Button 1034 allows the user to return to the previous screen 1078. Button 1038 connects the user to help screen 1078. Exit button 1040 returns the user to the main welcome display screen 1002. Window 1086 shows the user the text message that they prepared via keyboard 1042, keyboard 134, or screen navigational tool 136. The text messages from operator 106 appear in window 1088. Once the user is ready to transmit their message to operator 106, the user triggers send message button 1090.

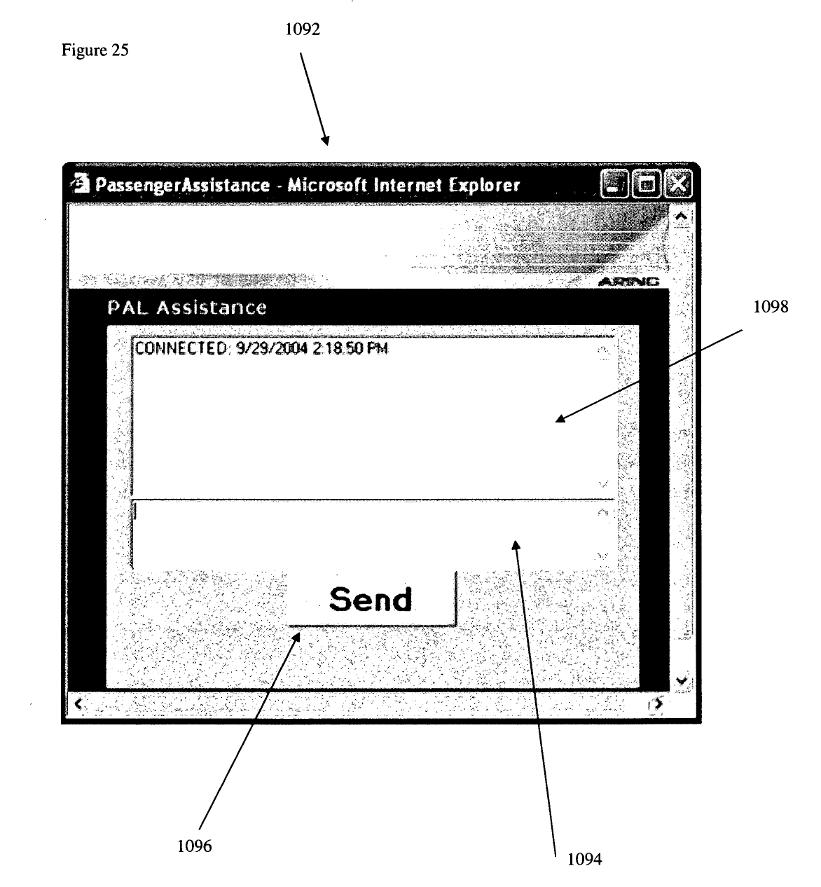

FIG. 25 depicts a live chat session window 1092 for Paging Assistance Locator (PAL) help. Live chat session window 1092 is a standard chat session window supported by a conventional internet browser that is used by operator 106 to communicate with user 102 in the help chat session. Chat session window 1092 includes a window 1094 where operator 106 types out their responses and questions to user 102 of PAL kiosk 112 who initiated the help session from computer screen display 1078. Operator 106 then uses button 1096 to send the text in window 1094 to the user of PAL kiosk 112. The text of the conversation between operator 106 and user 102 is displayed in window 1098. Chat session window 1092 is supported by communications center computer 116.

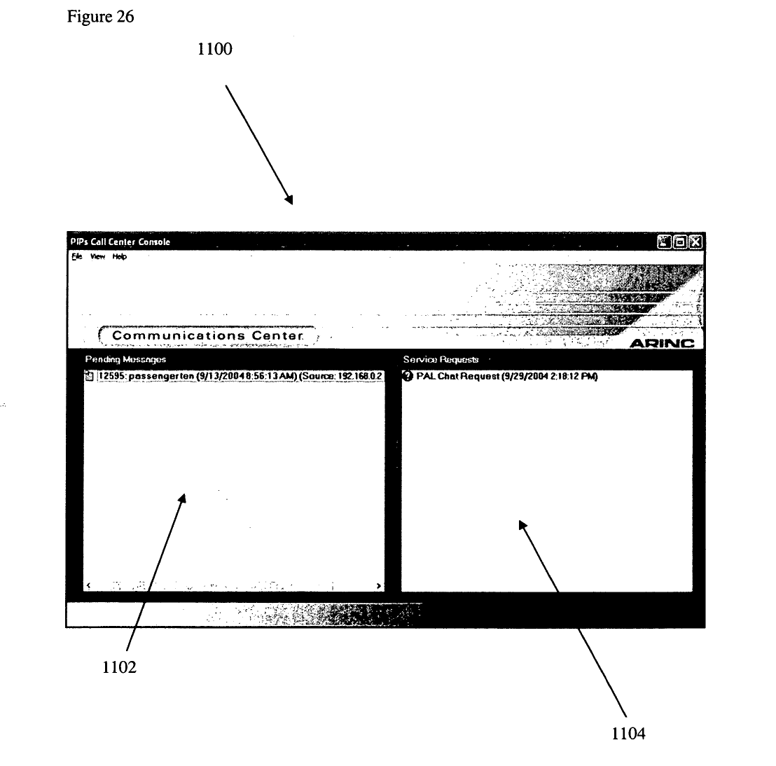

FIG. 26 depicts a message management computer screen display 1100. Computer screen display 1100 is supported by communications center computer 116 and supports the ability of operator 106 to manage the flow of paging information within PIPS 100. Window 1102 provides a listing of pending messages that have been collected by communications center computer 116 from one or more PAL kiosks 112 or from external communications interface 114. From this list, operator 106 selects and reviews the message to determine if it has appropriate content. If it does not, operator 106 will not post the message on PIPS 100. If it does have appropriate content, operator 106 will instruct PIPS 100 on where to post the message and in what manner. Window 1104 provides a listing of service requests received by communications center computer 116, such as PAL kiosk 112 help session requests. From window 1104, operator 106 can select, interact with, and manage specific service requests.

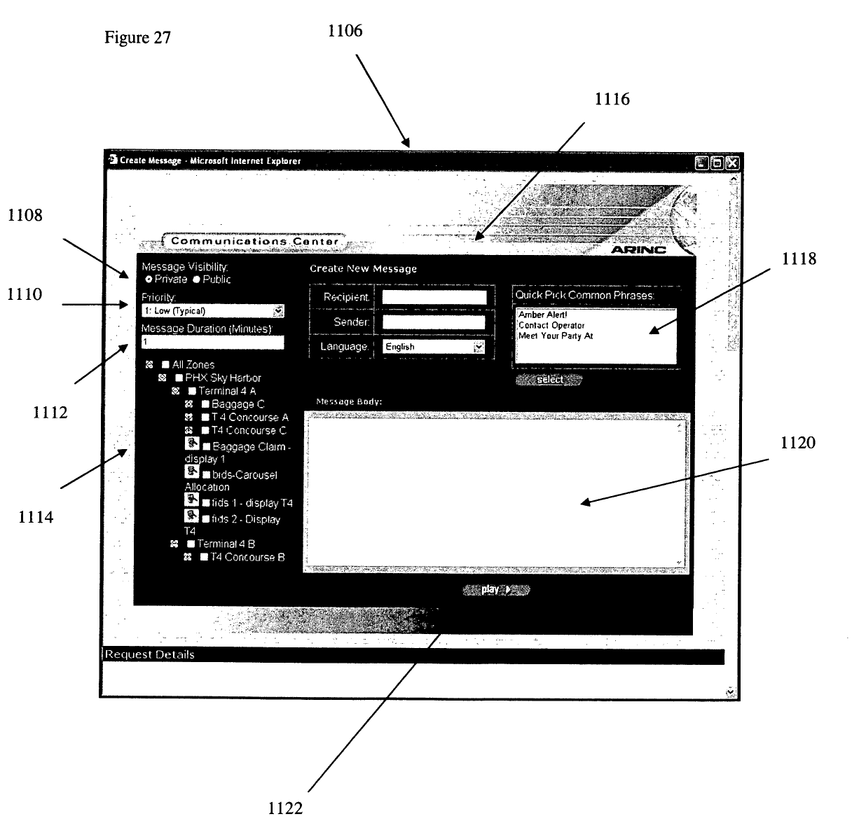

FIG. 27 depicts a message properties computer screen display 1106. With computer display screen 1106, operator 106 can designate various properties of the paging message in order to instruct PIPS 100 on how to display the paging information. In property 1108, operator 106 may designate whether the message is private or public. In property 1110, operator 106 may designate the priority level of the message. In property 1112, operator 106 may designate the duration the message will be posted on PIPS 100. Property 1114 allows operator 106 to designate which portion of PIPS 100 within location 118 will broadcast the paging message. With window 1116, operator 106 may create their own message for display on PIPS 100 by specifying the recipient, sender, and the language of the text message. For instance, airport security may use a standard dummy paging message to indicate that all members of airport security should return to a specific location for information on a specific matter. As such, operator 106 could create a dummy message for a fake-passenger named Lester Mainwaring, and leave a paging message instruction for Mr. Mainwaring to meet his party at baggage claim. Airport security would then understand this dummy message to mean that all members of airport security should report to their office. In window 1118, operator 106 can select from standard phrases to include in the paging message such as Amber Alert, contact operator, or the like. In window 1120, operator 106 can then type the specific paging message to be broadcast on PIPS 100. Button 1122 would uploads the message for broadcast on PIPS 100.

Although the present invention has been described in detail, it will be apparent to those of skill in the art that the invention may be embodied in a variety of specific forms and that various changes, substitutions, and alterations can be made without departing from the spirit and scope of the invention. The described embodiments are only illustrative and not restrictive and the scope of the invention is, therefore, indicated by the following claims.

We claim:

1. An information paging system, comprising:
a communications center computer network;
an audio broadcast system in communication with said communications center computer network;
a visual broadcast system in communication with said communications center computer network; and
at least one kiosk in communication with said communications center computer network, said kiosk supporting an interactive software application whereby users can enter and retrieve a set of paging information, said interactive software application is configured to transmit said set of paging information to said communications center computer network when it is entered into said kiosk, and said communications center computer network is configured to broadcast said set of paging information to said audio broadcast system, said visual broadcast system, and said kiosk.

2. The information paging system of claim 1, further comprising an external communications interface in communication with said communications center computer network, said external communications interface configured to accept an external set of paging information from a communications device external to said information paging system, said external communications interface configured to transmit said external set of paging information to said communications center computer network that then broadcasts said external set of paging information to said audio broadcast system, said visual broadcast system, and said kiosk.

3. The information paging system of claim 1, further comprising a paging information analysis application that determines whether a content of said set of paging information is suitable for broadcast over said information paging system.

4. The information paging system of claim 1, further comprising a broadcast location software module that determines what portions of said audio broadcast system, said visual broadcast system, and said kiosk in a particular location will broadcast said set of paging information.

5. The information paging system of claim 1, said kiosk further comprising a screen navigational tool allowing for an operation of said interactive software application.

6. The information paging system of claim 1, said interactive software application including a help module that configured to support a live chat session to provide customer support with operating said interactive software application.

7. The information paging system of claim 1, wherein said set of paging information is configured to scroll across said visual broadcast system.

8. The information paging system of claim 1, wherein said set of paging information includes the name of a person who has been paged and a text page message.

9. A method for managing paging information, comprising:
receiving a set of paging information;
transmitting said set of paging information to a communications center computer network;
reviewing the content of said set of paging information;
determining at least one location to broadcast said set of paging information; and
broadcasting said set of paging information over an audio broadcast system in communication with said communications center computer network, a visual broadcast system in communication with said communications center computer network, and a kiosk in communication with said communications center computer network that are located within said at least one location.

10. The method for managing paging information of claim 9, further comprising entering said set of paging information from a kiosk.

11. The method for managing paging information of claim 10, wherein said set of paging information is entered through an interactive software application supported on said kiosk.

12. The method for managing paging information claim 10, wherein said set of paging information is received by an external communications interface in communication with said communications center computer network.

13. The method for managing paging information of claim 9, further comprising rejecting said set of paging information from broadcast.

14. The method for managing paging information of claim 9, further comprising retrieving said set of paging information from a kiosk.

15. The method for managing paging information of claim 9, wherein retrieving said set of paging information from said kiosk occurs through said interactive software application.

16. The method for managing paging information of claim 9 further comprising conducting a live help chat session through said interactive software application.

17. The method for managing paging information of claim 9 further comprising scrolling said set of paging information across a display panel.
